(19) United States
(12) Patent Application Publication
(10) Pub. No.: US 2003/0038529 A1
(43) Pub. Date: Feb. 27, 2003

(54) Fixing holder for a wheel cover

(76) Inventors: Long-Chuan Hsu, Tainan Hsien (TW); Lung-Hung Hsu, Tainan Hsien (TW); Gary E. Adamson, Bristol, IN (US)

Correspondence Address: ROSENBERG, KLEIN & LEE, 3458 ELLICOTT CENTER DRIVE-SUITE 101, ELLICOTT CITY, MD, 21043, US

(21) Appl. No.: 09/933,748

(22) Filed: Aug. 22, 2001

(51) Int. Cl. B60B 7/14

(52) U.S. Cl. 301/37.371; 301/37.106

(57) ABSTRACT

A fixing holder for a wheel cover, relates to a curved plate having an arch at its middle section, two fixing plates extending from both lower ends of the arch, a screw eye provided in the top of the arch, and two insertion holes each respectively provided in the fixing plates at a distance equal to that of two neighboring genuine bolts supplied with the genuine wheel shaft. At least two fixing holders are used for each having its two insertion holes to meet two genuine bolts at symmetrical extremes that penetrate through the wheel shaft to lock up the wheel to the wheel shaft, and the two fixing holders being locked up to genuine bolts by means of thin nuts so that two penetration holes each provided in the wheel cover in relation to the screw eye in the top of the arch of the fixing holder for the wheel cover to be directed fixed into the wheel with a bolting element.

### BACKGROUND OF THE INVENTION

(a) Field of the Invention

The present invention relates to a fixing holder for a wheel cover, and more particularly, to one directly adapt to genuine locking bolts to facilitate the mounting of the bolts to the wheel cover.

(b) Description of the Prior Art

Each wheel of a larger vehicle is usually mounted with a wheel cover for improved appearance. A rear wheel to the vehicle generally comes in a pair of tires with two wheels connected by the rear wheel shaft, thus the style of the rear wheels is different from that of the front wheels of the same vehicle. Wherein, the front wheel similar to that with a general smaller passenger car is not provided with any concave depth while the rear wheel forms a concave to facilitate connection by the rear wheel shaft. Accordingly, the front wheel cover is designed with a strict arch and can be directly integrated with the wheel. The rear wheel cover comprises a drum containing a cap to be separated manufactured for assembly. The center of the drum is formed as a wheel shaft hole and the cap is welded to the hole. Or, alternatively, multiple holes are provided on the circumference of the wheel shaft hole and that of the cap for the wheel cover to be locked up to the rear wheel with bolts (or with bolts supplied with the genuine wheel shaft) to become an integral rear wheel cover. Furthermore, the wheel, either for the front wheel or for the rear wheel, is essentially structured as to have the genuine bolts supplied with the genuine wheel shaft to penetrate those holes pre-bored in the wheel. Then the wheel is fixed to the wheel shaft by screwing the genuine nuts to those protruded genuine bolts. Upon assembling the wheel cover in the prior art, the wheel cover of corresponding specification is used. Wherein, the genuine nuts mounted on the genuine bolts must be removed first, then each pre-bored hole on the wheel cap receives its corresponding genuine bolt protruding from the wheel, and the genuine bolt exposed out of the wheel cap is locked with the genuine nut for the connection area on the wheel cover to tightly hold against the surface of the wheel.

However, the wheel cover can only be mounted by first having all the genuine nuts removed, then locked in position with the genuine nuts followed with alignment routines. The whole process is time consuming, and the style of the wheel cover is limited due to it must provide all the holes in relation to the number of the genuine bolt attached to the wheel shaft.

### SUMMARY OF THE INVENTION

The primary purpose of the present invention is to provide a fixing holder for a wheel cover that can be directly to be connected to genuine bolts locked onto the wheel, so to facilitate the locking of the wheel cover by means of bolting elements. To achieve the purpose, the fixing holder relates to a plate having an arch at its central section; a fixing plate each extending symmetrically from both lower ends of the arch, a screw eye being provided in the top of the arch, and an insertion hole is each provided in the two fixing plates at the ends of the fixing holder in relation to the spacing between two neighboring genuine bolts on the wheel shaft. Two or more than two fixing holders are used to have their insertions holes provided in those fixing plates at both ends of the fixing holders to connect to two genuine bolts provided at symmetrical two ends locking the wheel, then both of the two fixing holders are secured with the genuine bolts locked up with thin nuts; and the wheel cover is mounted by direct insertion of the bolting elements through two holes pre-bored in relation to those screw eyes in the top of the arch of each of the fixing holders.

### BRIEF DESCRIPTION OF THE DRAWINGS

FIG. 1 is a perspective view showing a structure of a preferred embodiment of the present invention.

FIG. 2 is a perspective view showing an assembly of the preferred embodiment in relation to an assembly of a rear wheel and its wheel cover.

FIG. 3 is a sectional view of the combination of the preferred embodiment adapted to the rear wheel and its wheel cover.

FIG. 4 is a sectional view showing the rear wheel cover adapted to the preferred embodiment of the invention.

FIG. 5 is a sectional view showing a combination of the preferred embodiment of the present invention adapted to a deeper rear wheel and its wheel cover.

FIG. 6 is a sectional view of another combination of the preferred embodiment of the present invention adapted to a front wheel and its wheel cover.

### DETAILED DESCRIPTION OF THE PREFERRED EMBODIMENTS

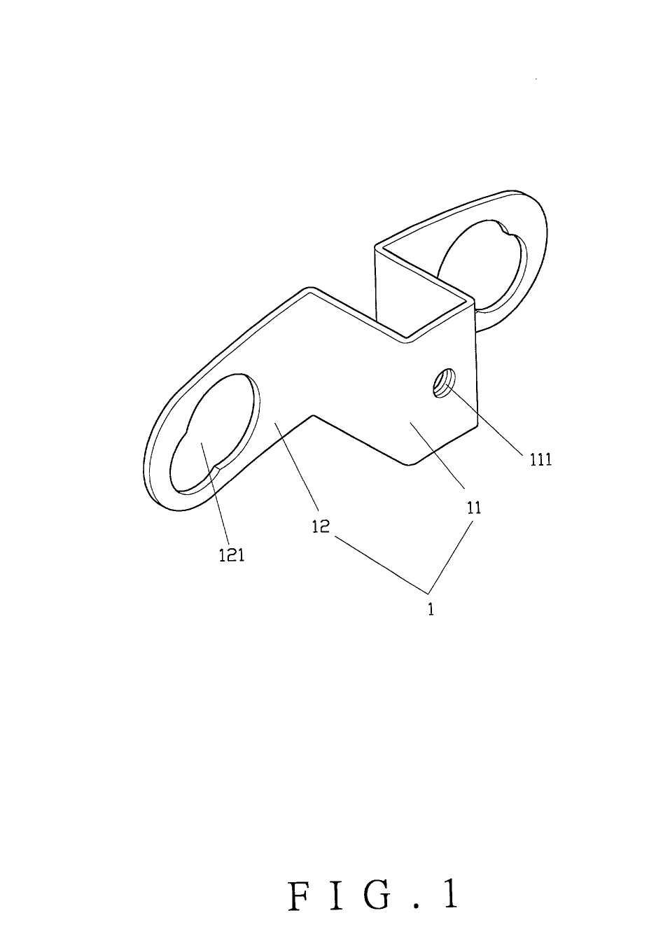

Referring to FIG. 1, the present invention exclusively for mounting a wheel cover to a larger vehicle essentially comprises a fixing holder (1) related to a curved plate having an arch (11) at its middle section. Two fixing plates (12) extend symmetrically from both lower ends of the arch (11). A screw eye (111) is bored in the top of the arch (11), and an insertion hole (121) is each provided in the fixing plates (12) in relation to the spacing between two neighboring genuine bolts of the wheel shaft. The insertion hole (121) may be provided in a shape of a bottle gourd in case of any difference exists between two genuine bolts.

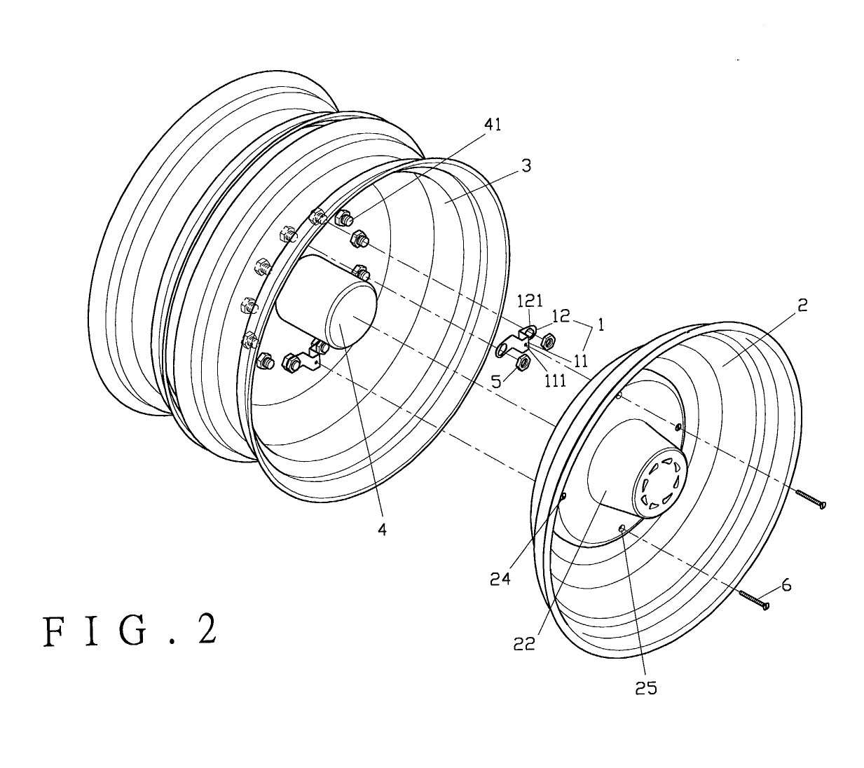

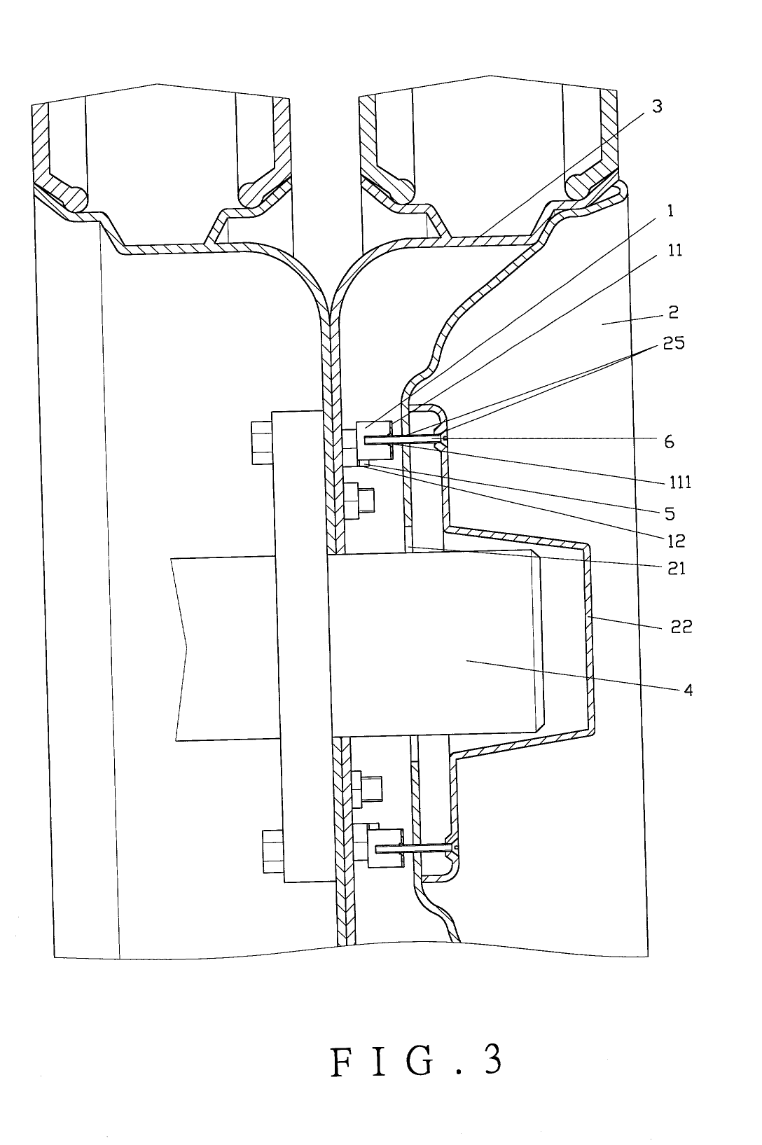

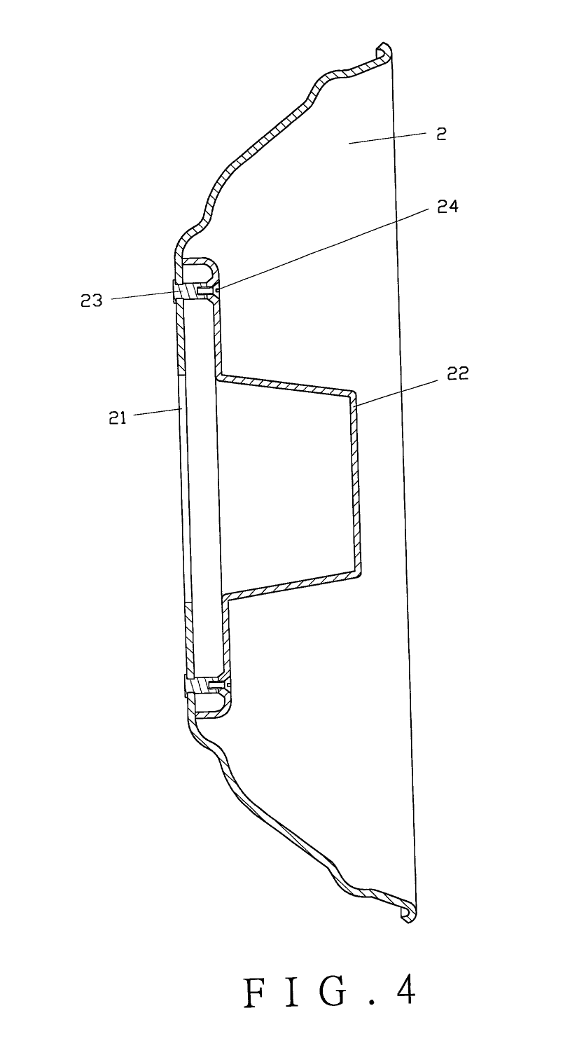

As illustrated in FIGS. 2 and 3, upon mounting the fixing holder (1) to lock up a wheel cover (2), at least two fixing holders (1) are fixed to a rear wheel (3). Each the fixing holder (1) is fixed to a pair of two neighboring genuine bolts (41) via the two insertion holes (121) of the fixing plates (12) of the fixing holder (1). The two pairs of genuine bolts (41) are located symmetrically at both sides of a wheel shaft (4) locked up by the genuine bolts (41) and inserted with the rear wheel (3). Multiple thin nuts (5) then are mounted through those genuine bolts (41) that fix the fixing plates (12) of the fixing holder (1) so to secure the two fixing holders (1). As illustrated in FIG. 4, a wheel shaft hole (21) is provided in the center of the main portion of the wheel cover (2) to be adapted to the rear wheel (3) and the wheel shaft hole (21) is aligned at the center of a cap (22) of the wheel cover (2). Two rods (23) accommodating each a screw eye are provided between the cap (22) and the shaft wheel hole (21) to respectively receive insertion of a screw (24) to lock up the nut (22) to the shaft wheel hole (21). Two penetration holes (25) are provided in the wheel cover (2) in relation to each screw eye (111) provided in the top of the arch (11) of each of the two fixing holders (1) that already locked onto the genuine bolts (41). That is, the two penetrations holes (25) may be separated from each other at a distance equal to that between two genuine bolts (41) at symmetrical ends to the wheel shaft (4) and the number of the fixing holder (1) may be increased depending on the individual application. A bolting element (6) is directly penetrating through the penetration hole (25) of the wheel cover (2) to lock in the screw eye (111) of the arch (11) of the fixing holder (1), thus to force the wheel cover (2) moving inwardly in relation to the rear wheel (3) for the circumference of the wheel cover (2) and that of the rear wheel (3) to firmly hold against each other. Wherein, the height of the arch (11) of the fixing holder (1) provides the freedom for the bolting element (6) in proper length to screw in, thus to prevent the bolting element (6) from failing to press against the wheel cover (2) to firmly hold against the rear wheel (3) once the bolting element (6) reaches the surface of the rear wheel (3).

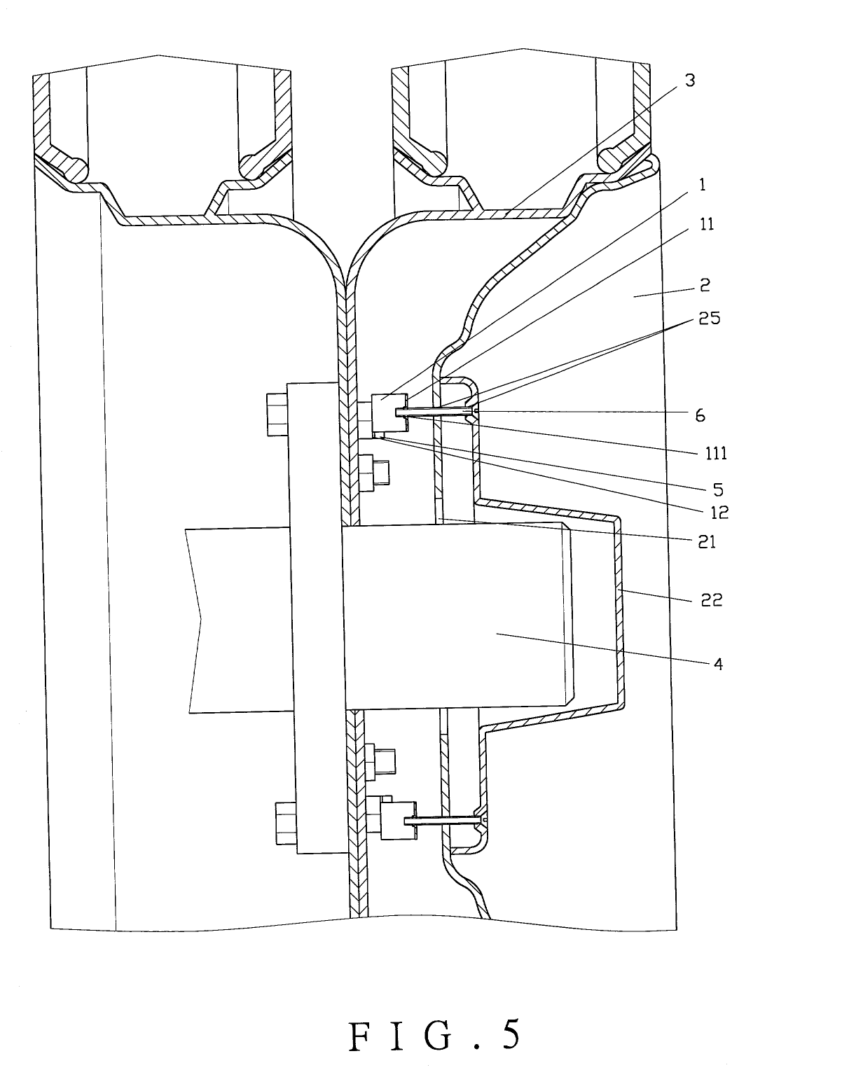

Furthermore, as illustrated in FIG. 5, in case of the rear wheel (3) has a deeper specification, the portion of the length of the bolting element (6) entering in the arch (11) of the fixing holder (1) will become shorter. Therefore, the bolting element (6) has to be longer.

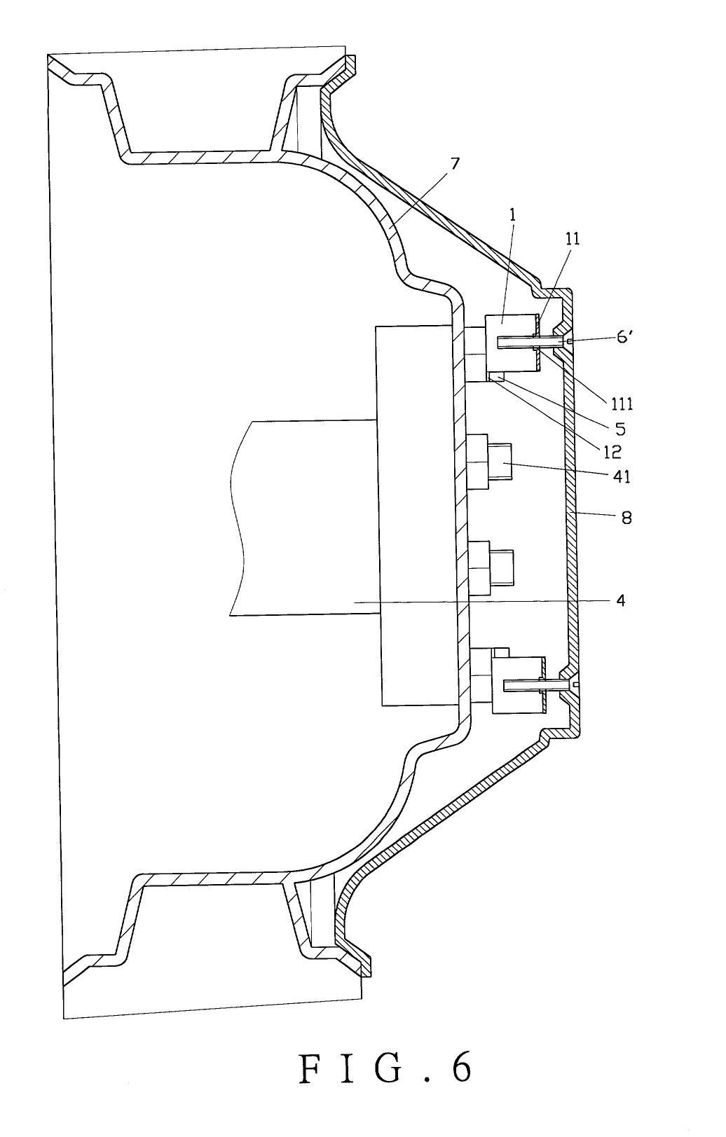

Now referring to FIG. 6, upon mounting the fixing holder (1) in conjunction with the assembly of a front wheel (7) and a wheel cover (8), the same mounting and locking procedures disclosed above for the rear wheel is applied with the exception that a shorter bolting element (6′) is used.

As disclosed above, a fixing holder for a wheel cover provided by the present invention can be directly locked to the genuine bolts on a wheel so to lock up a wheel cover without removing genuine nuts to make the mounting and removal of the wheel cover easier and more convenient.

I claim:

1. A fixing holder for a wheel cover comprising a curved plate with its middle section in arch shape, two fixing plates extending symmetrically from both lower ends of said arch, and two insertion holes being each respectively provided in said fixing plates at a distance equal to the spacing between two neighboring genuine bolts supplied with a wheel shaft.

2. A fixing holder for a wheel cover as claimed in claim 1, said insertion hole is in the shape of a bottle gourd having two holes in different diameters that crossing each other.
